(19) United States
(12) Patent Application Publication
(10) Pub. No.: US 2025/0300434 A1
(43) Pub. Date: Sep. 25, 2025

(54) POWER DISTRIBUTION SYSTEM

(71) Applicant: Brand Shared Services LLC, Atlanta, GA (US)

(72) Inventors: Amrith Singh THAKUR, Katy, TX (US); Eduardo Fernando D'ORACIO DE ALMEIDA, League City, TX (US); Diego Arturo EDWARDS SORDO, Houston, TX (US)

(73) Assignee: Brand Shared Services LLC, Atlanta, GA (US)

(21) Appl. No.: 19/085,528

(22) Filed: Mar. 20, 2025

Related U.S. Application Data
(60) Provisional application No. 63/568,319, filed on Mar. 21, 2024.

(51) Int. Cl. H02B 1/01

(52) U.S. Cl. CPC H02B 1/011; H02B 1/012

(57) ABSTRACT

A power distribution management unit includes a frame assembly, an input enclosure, a three-phase enclosure, a transformer enclosure, and a single-phase enclosure. The frame assembly includes a base and a framework coupled to and extending from the base. The input enclosure, the three-phase enclosure, the transformer enclosure, and the single-phase enclosure are coupled to and supported above the base by the framework. The input enclosure receives an input power. The three-phase enclosure receives the input power and includes a first high-power outlet rated at a first current value, a second high-power outlet rated at a second current value, and a first and a second high-power switch. The first current value is higher than the second current value. The transformer enclosure converts the input power from three-phase power to single-phase power. The single-phase enclosure receives the single-phase power and includes a plurality of intermediate-power outlets and a plurality of low-power outlets.

### CROSS-REFERENCE TO RELATED PATENT APPLICATIONS

The present application claims the benefit of and priority to U.S. Provisional Patent Application No. 63/568,319, filed Mar. 21, 2024, which is incorporated herein by reference in its entirety.

### BACKGROUND

A power enclosure typically receives input power and supplies output power to a machine, device, or another power-receiving component.

### SUMMARY

In one embodiment, a power distribution management unit comprises a frame assembly, an input enclosure, a three-phase enclosure, a transformer enclosure, and a single-phase enclosure. The frame assembly comprises a base and a framework coupled to and extending from the base. The input enclosure is coupled to and supported above the base by the framework and the input enclosure is configured to receive an input power. The three-phase enclosure is coupled to and supported above the base by the framework. The three-phase enclosure receives the input power and comprises a first high-power outlet, a first high-power switch configured to selectively supply or disconnect power to the first high-power outlet, a second high-power outlet, and a second high-power switch configured to selectively supply or disconnect power to the second high-power outlet. The first high-power outlet is rated at a first current value and the second high-power outlet is rated at a second current value. The first current value is higher than the second current value. The transformer enclosure is coupled to and supported above the base by the framework. The transformer enclosure includes a stepdown transformer configured to convert the input power from three-phase power to single-phase power. The single-phase enclosure is coupled to the framework and the single-phase enclosure receives the single-phase power. The single-phase enclosure comprises a plurality of intermediate-power outlets and a plurality of low-power outlets.

In another embodiment, a power distribution management unit comprises a frame assembly, an input enclosure, a three-phase enclosure, a transformer enclosure, and a single-phase enclosure. The frame assembly comprises a base and a framework coupled to and extending from the base. The input enclosure is coupled to and supported above the base by the framework and the input enclosure is configured to receive an input power. The three-phase enclosure is coupled to and supported above the base by the framework. The three-phase enclosure receives the input power and comprises a first high-power outlet, a second high-power outlet, and a light indicator configured to indicate a status of the first high-power outlet or the second high-power outlet. The first high-power outlet is rated at a first current value and the second high-power outlet is rated at a second current value. The first current value is higher than the second current value. The light indicator comprises a first light source configured to emit light, a second light source configured to emit light, and a third light source configured to emit light. The first light source is configured to cease emitting light when a first phase loss occurs. The second light source is configured to cease emitting light when a second phase loss occurs. The third light source is configured to cease emitting light when a third phase loss occurs. The transformer enclosure is coupled to and supported above the base by the framework. The transformer enclosure includes a stepdown transformer configured to convert the input power from three-phase power to single-phase power. The single-phase enclosure is coupled to the framework and the single-phase enclosure receives the single-phase power. The single-phase enclosure comprises a plurality of intermediate-power outlets and a plurality of low-power outlets.

In another embodiment, a power distribution management unit comprises a frame assembly, an input enclosure, a three-phase enclosure, a transformer enclosure, and a single-phase enclosure. The frame assembly comprises a base and a framework coupled to and extending from the base. The input enclosure is coupled to and supported above the base by the framework and the input enclosure is configured to receive an input power. The three-phase enclosure is coupled to and supported above the base by the framework. The three-phase enclosure receives the input power and comprises a first high-power outlet and a second high-power outlet. The first high-power outlet is rated at a first current value and the second high-power outlet is rated at a second current value. The first current value is higher than the second current value. The transformer enclosure is coupled to and supported above the base by the framework. The transformer enclosure includes a stepdown transformer configured to convert the input power from three-phase power to single-phase power. The single-phase enclosure is coupled to the framework and the single-phase enclosure receives the single-phase power. The single-phase enclosure comprises a plurality of intermediate-power outlets and a plurality of low-power outlets. The transformer enclosure is below the single-phase enclosure and between the input enclosure and the three-phase enclosure.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements unless otherwise indicated, in which:

FIG. 1 is a front, left perspective view of a power distribution management system, according to an exemplary embodiment;

FIG. 2 is a left perspective view of the power distribution management system of FIG. 1;

FIG. 3 is a left side view of the power distribution management system of FIG. 1;

FIG. 4 is a block diagram of the power distribution management system of FIG. 1;

FIG. 5 is a block diagram of the power distribution management system of FIG. 1; and

FIG. 6 is a perspective view of the power distribution management system of FIG. 1.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Industries across various sectors are continuously seeking innovative solutions to optimize their operational processes and enhance efficiency. One critical aspect of operations is the management of electrical power distribution, which plays a pivotal role in ensuring seamless workflow and productivity. Conventional Power Distribution Management Units (PDMUs) typically offer fixed output voltages, limiting their applicability in diverse operational environments. Operational requirements (e.g., output voltage requirements, space requirements, etc.) of industries can very across industries and production lines and dynamically change along with the business. The conventional solution is to provide multiple PDMUs that fit the needs (e.g., power requirements, voltage requirements, etc.) of each of the areas. But this solution is expensive (e.g., due to purchasing multiple unique units, etc.), produces a large space claim, and does not allow flexibility in changing operational requirements. This solution is particularly inefficient in industries where space is a limiting factor (e.g., existing manufacturing plants that must accommodate a new production line within existing space constraints, etc.) or industries where capital does not allow for extensive modifications or infrastructure changes.

The systems and methods of the present disclosure provide a power distribution management unit (PDMU) that is safety oriented and can streamline power distribution in diverse settings (e.g., commercial buildings, industrial facilities, manufacturing plants, etc.). Exemplary embodiments described herein relate to a PDMU with a frame assembly, an input enclosure, a three-phase enclosure, a transformer enclosure, and a single-phase enclosure. The input enclosure is configured to receive input power. The three-phase enclosure receives the input power and includes one or more first high-power outlets and one or more second high-power outlets, where the first high-power outlets are rated at a first current value and the second high-power outlets are rated at a second current value, with the first current value being different (e.g., higher) than the second current value. The transformer enclosure includes a stepdown transformer configured to convert the input power from a three-phase power to a single-phase power. The single-phase enclosure receives the single-phase power and includes a plurality of intermediate-power outlets and a plurality of low-power outlets. In this way, for example, the PDMU of the present disclosure is capable of servicing various power output requirements simultaneously from a single unit. Additionally, each of the power outlets may be connected to a dedicated circuit breaker that provide individualized protection against overloads and electrical faults, and ensures that in the event of an issue with one circuit, the issue is isolated and does not disrupt the other power outlets. These and other features and advantages of the present application will be described in further detail below with reference to the figures.

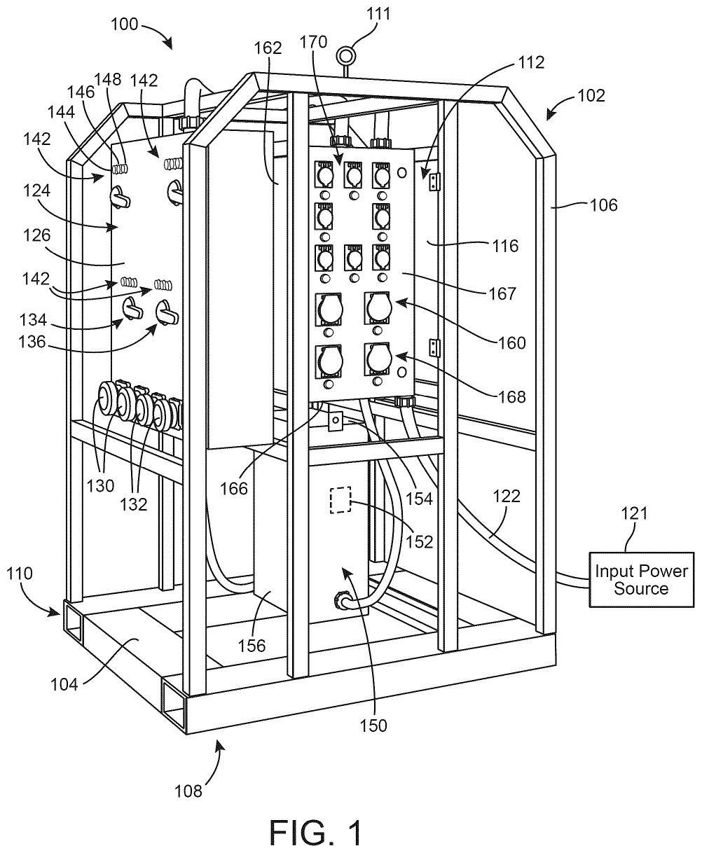

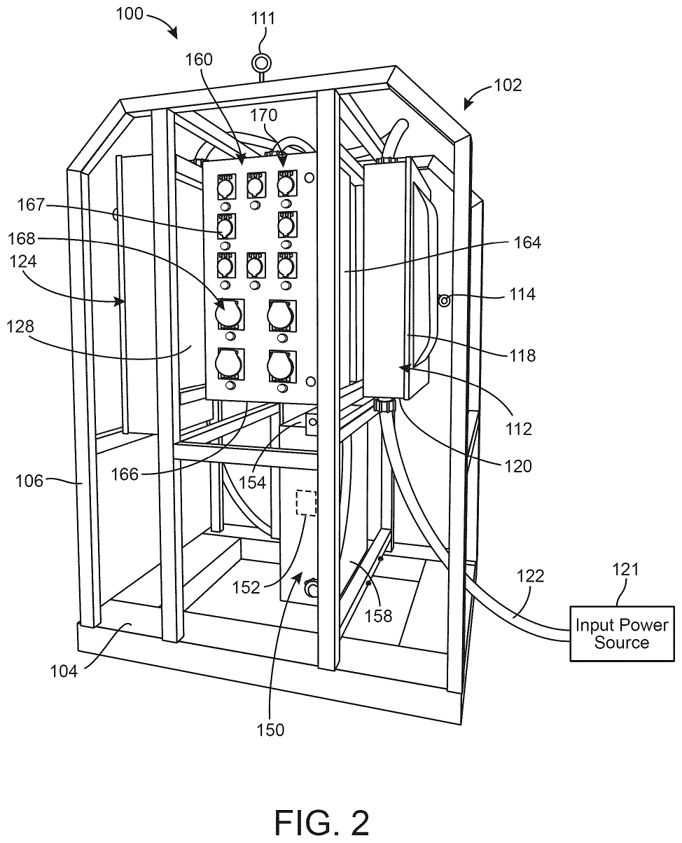

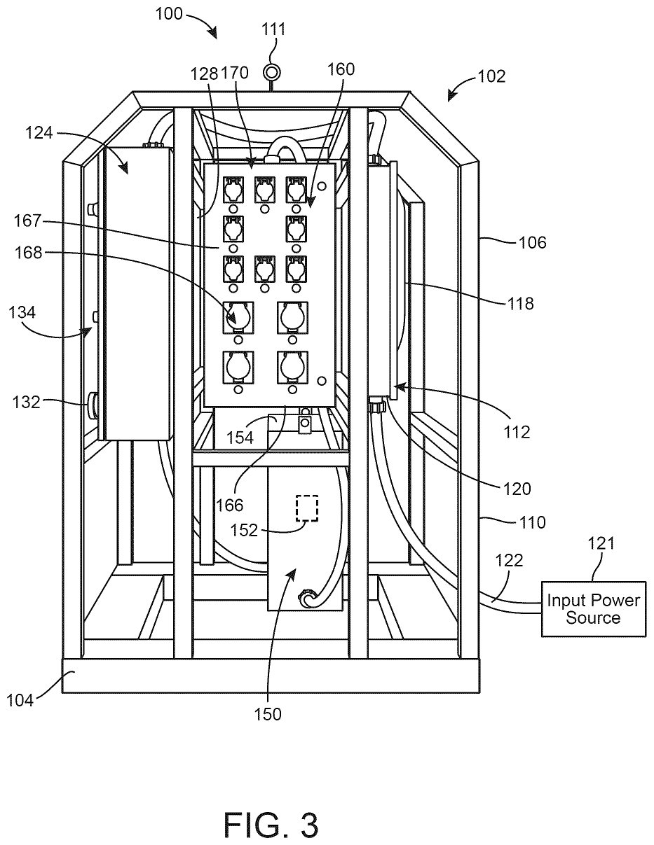

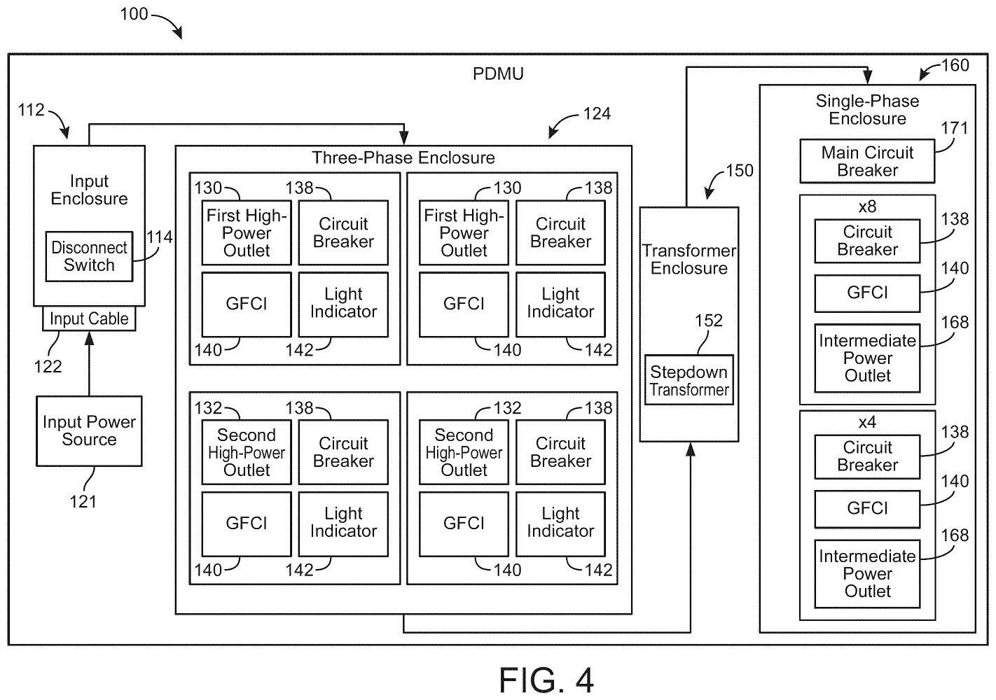

FIGS. 1-5 show a PDMU 100 (e.g., power management unit, power control supply module, power distribution unit, power control module, etc.), according to an exemplary embodiment. In general, the PDMU 100 is configured to supply power to a plurality of power-receiving components or machines at various output voltages and rated currents. The PDMU 100 includes a frame assembly 102 (e.g., cage fabrication, support assembly, etc.). The frame assembly 102 includes a base 104 (e.g., foundation, foot, stand, etc.) and a framework 106 (e.g., cage, support system, support, scaffolding, etc.). The base 104 is supported on a substantially horizontal surface (e.g., floor, ground, etc.) and comprises a pair of fork pockets 108 (e.g., fork entry, access channels, etc.) defined by through channels 110 (e.g., pockets, tunnels, etc.) formed in the base 104. The pair of fork pockets 108 are configured receive forklift forks to aide in the mobility of the PDMU 100.

The framework 106 is coupled to the base 104 and extends away from the base 104 (e.g., in a direction away from the floor). The framework 106 includes a plurality of frames (i.e., beams, rods, supports, etc.) coupled together. In some embodiments the PDMU 100 is about 1300 lbs., is dimensioned at about 49 (length)×42 (width)×75 (height) inches and has a NEMA type 3R rating. In other embodiments, the PDMU 100 is a NEMA type 12 rating. In some embodiments, one or more eyebolts 111 are coupled to a top side of the framework 106, which provides a connection point for a lifting device to lift and move the PDMU 100.

The PDMU 100 includes an input enclosure 112 (e.g., first cabinet, power enclosure, etc.) having a disconnect switch 114 (e.g., insulator switch, safety switch, load break switch, etc.) that is electrically coupled to the input enclosure 112. The input enclosure 112 includes an input enclosure first surface 116 (e.g., side, etc.) parallel to an input enclosure second surface 118 (e.g., side, etc.). The input enclosure first surface 116 and the input enclosure second surface 118 are connected by and perpendicular to an input enclosure third surface 120 (e.g., side, etc.). The input enclosure third surface 120 is parallel to the base 104.

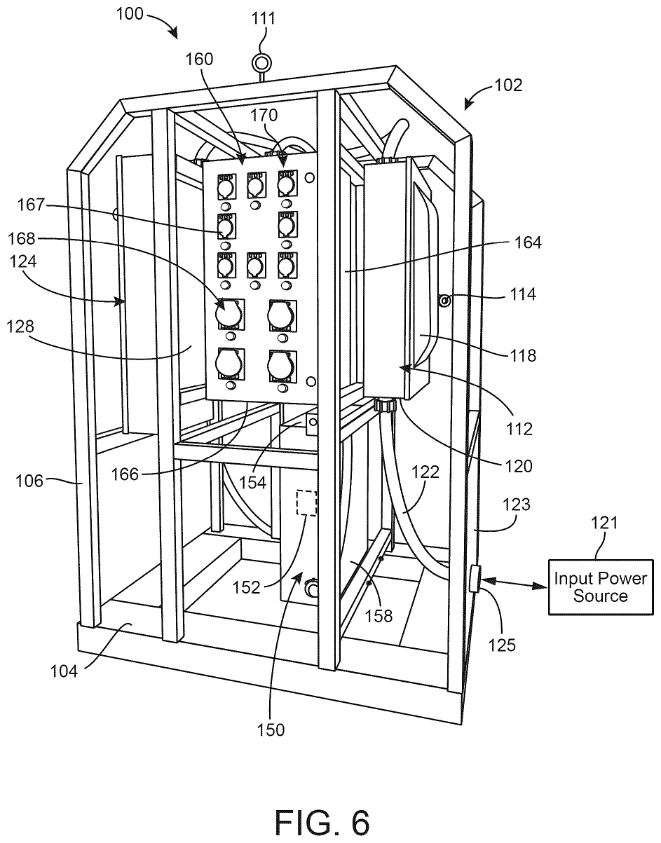

The input enclosure 112 is coupled to and supported above the base 104 by the framework 106. The input enclosure 112 is configured to receive an input power from an input power source 121 (e.g., generator, commercial power source, utility power source, etc.) through an input cable 122 (e.g., 2/04 Conductor SOOW, etc.). The input power source 121 can be any power source capable of proving about a three-phase 480VAC input voltage, about 166 kVA or 135 KW of power, and about a 60 Hz frequency. In some embodiments, the input power source 121 can provide about 200 A of current. In some embodiments, the input power source 121 can provide about 400 A current. The input power source 121 can be any power source that supplies about a three-phase 480VAC input voltage, about 322 kA or 270 KW of power, and about a 60 Hz frequency. In some embodiments, the input enclosure 112 may be coupled to and supported by the base 104. In some embodiments, the PDMU 100 includes an input power panel 123 that is coupled to an exterior of the framework 106 on a side thereof adjacent to the input enclosure 112 (see, e.g., FIG. 6). The input power panel 123 includes an input power socket 125 that is configured to receive an input power plug that is electrically connected to the input power source 121. In this way, for example, wiring of the input power to the PDMU 100 is simplified because an electrician may only be required to wire from the input power source 121 to the input power plug, which can then be plugged into the PDMU 100 at the input power socket 125, rather than wiring directly from the input power source 121 to the input enclosure 112.

The PDMU 100 includes a three-phase enclosure 124 (e.g., cabinet, etc.) coupled to the framework 106 and supported above the base 104 by the framework 106. The three-phase enclosure 124 is configured to receive the input power from the input enclosure 112. The three-phase enclosure 124 includes a three-phase enclosure first surface 126 (e.g., side, etc.) that is perpendicular to the base 104 and parallel to a three-phase enclosure second surface 128 (e.g., side, etc.). In some embodiments, the three-phase enclosure 124 is a rectangular prism, and an inside of the three-phase enclosure 124 can be accessed from the three-phase enclosure first surface 126. In some embodiments, the three-phase enclosure 124 is accessed from an alternate location (e.g., the three-phase enclosure second surface 128, etc.

In general, the three-phase enclosure 124 includes a plurality of high-power outlets that are externally accessible so that a user can plug into one or more of the high-power outlets and be supplied with three-phase power. In some embodiments, the three-phase enclosure 124 includes a first set of outlets (e.g., first high-power outlets) that are rated at a first current value, and a second set of outlets (e.g., second high-power outlets) that are rated at a second current value that is different (e.g., higher) than the first current value. In the illustrated embodiments, the three-phase enclosure 124 includes one or more first high-power outlets 130 (e.g., socket, receptacle, etc.) and one or more second high-power outlets 132 (e.g., socket, receptacle, etc.). In some embodiments, the three-phase enclosure 124 includes two of the first high-power outlets 130 and two of the second high-power outlets 132. In the illustrated embodiment, the first high-power outlets 130 and the second high-power outlets 132 are arranged in a line substantially parallel to the base 104. In some embodiments, the three-phase enclosure 124 includes more than two of the first high-power outlets 130. In some embodiments, the three-phase enclosure 124 includes more than two of the second high-power outlets 132. In some embodiments, the first high-power outlets 130 and the second high-power outlets 132 are arranged in an alternate formation (e.g., staggered relative to the base 104, etc.).

The first high-power outlets 130 are mounted to and extend outwardly from the three-phase enclosure first surface 126. Similarly, the second high-power outlets 132 are mounted to and extend outwardly from the three-phase enclosure first surface 126. The first high-power outlets 130 are configured to output three-phase power with a voltage of about 480V and a rated current of about 60 A. The second high-power outlets 132 are configured to output three-phase power with a voltage of about 480V and a rated current of about 30 A. In other words, the first high-power outlets 130 are rated at a first current value and the second high-power outlets 132 are rated at a second current value, with the first current value being higher than the second current value, and the first high-power outlets 130 and the second high-power outlets 132 are rated at or configured to output the same voltage (e.g., the same voltage as the input power).

In general, each of the first high-power outlets 130 and the second high-power outlets 132 is connected to a dedicated switch that is configured to selectively supply or disconnect power to the respective outlet (e.g., an on/off switch). For example, the three-phase enclosure 124 includes a pair of first high-power switches 134 (e.g., lever, control, button, etc.) and a pair of second high-power switches 136 (e.g., lever, control, button, etc.). The first high-power switches 134 are mounted to and extend outwardly from the three-phase enclosure first surface 126, and the second high-power switches 136 are mounted to and extend outwardly from the three-phase enclosure first surface 126. The first high-power outlets 130 and the second high-power outlets 132 are located below the first high-power switches 134 and the second high-power switches 136, respectively. Each of the first high-power switches 134 is configured to selectively supply or disconnect power to a dedicated one of the first high-power outlets 130. Each of the second high-power switches 136 is configured to selectively supply or disconnect power to a dedicated one of the second high-power outlets 132.

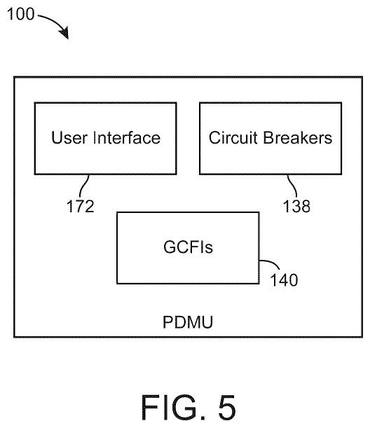

In general, the PDMU 100 includes a plurality of circuit breakers 138 that are individually dedicated to each of the outlets mounted on the PDMU. For example, the three-phase enclosure 124 includes a dedicated circuit breaker 138 for each of the first high-power outlets 130 and the second high-power outlets 132 (see, e.g., FIG. 5). The circuit breakers 138 define the rated current for each of the first high-power outlet 130 and the second high-power outlet 132 (e.g., the circuit breakers 138 are rated to trip and prevent power being supplied to the first high-power outlet 130 and the second high-power outlet 132 at the first current value and the second current value, respectively). In addition to the circuit breakers 138, the three-phase enclosure 124 includes a plurality of ground-fault circuit interrupters (GFCIs) 140. Specifically, each of the first high-power outlets 130 and the second high-power outlets 132 is electrically coupled to a dedicated one of the GFCIs 140. In some embodiments, a sensitivity of the GFCIs 140 is about 30 mA. By dedicating one of the circuit breakers 138 and one of the GFCIs 140 to each of the first high-power outlets 130 and the second high-power outlets 132, the PDMU 100 provides individualized protection against overloads and electrical faults, and ensures that in the event of an issue with one of the first high-power outlets 130 and the second high-power outlets 132, the issue is isolated and does not disrupt the other power outlets.

The three-phase enclosure 124 includes a plurality of light indicators 142 (e.g., light emitting source, illuminant, lighting source, etc.) that are each mounted on and extend outwardly from the three-phase enclosure first surface 126. In general, one of the light indicators 142 is dedicated to each of the first high-power outlets 130 and the second high-power outlets 132 and is configured to indicate a status of power being supplied by the first high-power outlets 130 and the second high-power outlets 132. Each of the light indicators 142 includes a first light source 144 (e.g., illuminant, LED, bulb, etc.), a second light source 146 (e.g., illuminant, LED, bulb, etc.), and a third light source 148 (e.g., illuminant, LED, bulb, etc.). The first light source 144, the second light source 146, and the third light source 148 are arranged in a straight line substantially parallel to the base 104 and above corresponding one of the first high-power switches 134 and the second high-power switches 136 (e.g., the light indicator 142 for one of the first high-power outlets 130 is arranged above the first high-power switch 134 for that outlet, and so on). The first light source 144 is configured to emit light when power is being supplied to the respective outlet that the first light source 144 monitors, and cease emitting light when a first phase loss occurs (e.g., the first phase in the three-phase power drops out) or when power is not being supplied to the outlet (e.g., the switch is moved to an off position, the circuit breaker 138 trips, etc.). The second light source 146 is configured to emit light when power is being supplied to the respective outlet that the second light source 146 monitors, and cease emitting light when a second phase loss occurs (e.g., the second phase in the three-phase power drops out) or when power is not being supplied to the outlet (e.g., the switch is moved to an off position, the circuit breaker 138 trips, etc.). The third light source 148 is configured to emit light when power is being supplied to the respective outlet that the third light source 148 monitors, and cease emitting light when a third phase loss occurs (e.g., the third phase in the three-phase power drops out) or when power is not being supplied to the outlet (e.g., the switch is moved to an off position, the circuit breaker 138 trips, etc.). Accordingly, the light indicators 142 are configured to provide a visual indication when power is being supplied to the first high-power outlets 130 and the second high-power outlets 132, when one of the phases in the three-phase power supplied by the first high-power outlets 130 and the second high-power outlets 132, and when power is not being supplied to the first high-power outlets 130 and the second high-power outlets 132.

The PDMU 100 includes a transformer enclosure 150 (e.g., converter cabinet, etc.) that is coupled to and supported above the base 104 by the framework 106. The transformer enclosure 150 includes a stepdown transformer 152 (e.g., electrical transformer, etc.) configured to convert the input power from three-phase power to single-phase power. The transformer enclosure 150 includes a transformer enclosure first surface 154 parallel to the base 104, a transformer enclosure second surface 156, and a transformer enclosure third surface 158. The transformer enclosure first surface 154 connects and is perpendicular to the transformer enclosure second surface 156 and the transformer enclosure third surface 158. The transformer enclosure second surface 156 is parallel to the transformer enclosure third surface 158. In some embodiments the transformer enclosure 150 is coupled to and supported by the base 104.

The PDMU includes a single-phase enclosure 160 (e.g., cabinet, etc.) coupled to the framework 106 and supported above the base by the framework 106. The single-phase enclosure 160 is configured to receive the single-phase power from the transformer enclosure 150. The single-phase enclosure 160 includes a single-phase enclosure first surface 162 (e.g., side, etc.) parallel to a single-phase enclosure second surface 164 (e.g., side, etc.). The single-phase enclosure 160 includes a single-phase enclosure third surface 166 (e.g., side, etc.) perpendicular to the single-phase enclosure first surface 162 and the single-phase enclosure second surface 164.

In general, the single-phase enclosure 160 includes a plurality of intermediate-power outlets 168 (e.g., sockets, plugs, receptacles, etc.) and a plurality of low-power outlets 170 (e.g., sockets, plugs, receptacles, etc.) that are externally accessible so that a user can plug into one or more of the plurality of intermediate-power outlets 168 and the plurality of low-power outlets 170 and be supplied with single-phase power. In the illustrated embodiment, the plurality of low-power outlets 170 are arranged in a formation of substantially parallel lines to form a rectangular grid shape. In some embodiments, the plurality of low-power outlets 170 are arranged in an alternate formation (e.g., staggered relative to the base 104, etc.). In the illustrated embodiment, the plurality of intermediate-power outlets 168 are arranged in a formation of lines substantially parallel to the base 104. In some embodiments, the plurality of low-power outlets 170 are arranged in an alternate formation (e.g., staggered relative to the base 104, etc.).

The plurality of intermediate-power outlets 168 and the plurality of low-power outlets 170 are mounted to and extend outwardly from the single-phase enclosure fourth surface 167. Similarly, the plurality of low-power outlets 170 are mounted to and extend outwardly from the single-phase enclosure fourth surface 167. The plurality of intermediate power outlets 168 are configured output single-phase power with a voltage of about 240V and a rated current of about 30 A. The low-power outlets 170 are configured to output single-phase power with a voltage of about 120V and a rated current of about 20 A. In other words, the low-power outlets 170 and the intermediate-power outlets 168 are rated at different voltages and different currents.

In general, the single-phase enclosure 160 includes a main circuit breaker 171 and a plurality of the circuit breakers 138 that are individually dedicated to each of the outlets mounted on the single-phase enclosure 160 (see, e.g., FIG. 5). By dedicating one of the circuit breakers 138 to each of the intermediate-power outlets 168 and the low-power outlets 170, the PDMU 100 provides individualized protection against overloads and electrical faults, and ensures that in the event of an issue with one of the intermediate-power outlets 168 and the low-power outlets 170, the issue is isolated and does not disrupt the other power outlets. The main circuit breaker 171 is electrically coupled to all of the plurality of intermediate-power outlets 168 and all of the plurality of low-power outlets 170. In some embodiments, the single-phase enclosure 160 includes the plurality of GFCIs 140, and the plurality of intermediate-power outlets 168 and the plurality of low-power outlets 170 are electrically coupled to a respective one of the plurality of GFCIs 140.

In some embodiments, the PDMU 100 includes a user interface 172 (e.g., user display, control output, status display, etc.) coupled to the framework 106 (see, e.g., FIG. 6). In some embodiments, the PDMU 100 includes a plurality of user interfaces 172, for example, one user interface 172 for each of the input enclosure 112, the three-phase enclosure 124, and the single-phase enclosure 160 to display operating characteristics of the power distribution of these enclosures. In general, the user interface 172 is configured to display operating characteristics or data of the PDMU 100. The operating characteristics can include power to a component (e.g., the input power, a power to the first high-power outlet 130, a power to the second high-power outlet 132, a power to the plurality of intermediate-power outlets 168, a power to the stepdown transformer 152, etc.), voltage to a component (e.g., voltage to the first high-power outlet 130, etc.), or current to a component (e.g., current to the first high-power outlet 130, etc.). In other embodiments, the operating characteristics can include other measured values (e.g., efficiency, resistance, switch status, contactor status, GFCI status, etc.). In other embodiments, the user interface 172 is integrated into one of the enclosures. In other embodiments, the user interface 172 is nearby coupled to the framework 106. In other embodiments, the user interface 172 is arranged remotely from the framework 106 and wirelessly communicates the operating characteristics to the user interface (e.g., via telematics).

In general, the various enclosures of the PDMU 100 are all coupled to and supported on the framework 106, which enables the PDMU 100 to accommodate various output requirements on a single unit. In the illustrated embodiment, the input enclosure 112 is substantially parallel to a three-phase enclosure 124. The input enclosure first surface 116 is substantially parallel to the three-phase enclosure second surface 128. The single-phase enclosure 160 is between the input enclosure 112 and the three-phase enclosure 124. The single-phase enclosure first surface 162 is substantially parallel to and next to the three-phase enclosure second surface 128. The single-phase enclosure second surface 164 is substantially parallel and next to the input enclosure first surface 116. The transformer enclosure 150 is below the single-phase enclosure 160. The transformer enclosure first surface 154 is next to, below, and parallel to the single-phase enclosure third surface 166. The transformer enclosure 150 is between the input enclosure 112 and the three-phase enclosure 124. The transformer enclosure second surface 156 and the transformer enclosure third surface 158 are between the three-phase enclosure second surface 128 and the input enclosure first surface 116. In some embodiments, the input enclosure 112 is between three-phase enclosure 124 and the single-phase enclosure 160. In some embodiments, the three-phase enclosure 124 is between the single-phase enclosure 160 and the input enclosure 112. In some embodiments the single-phase enclosure 160 is below the transformer enclosure 150. In some embodiments the three-phase enclosure 124 is below the transformer enclosure 150. In some embodiments the input enclosure 112 is below the transformer enclosure 150. In some embodiments the transformer enclosure 150, the single-phase enclosure 160, the three-phase enclosure 124, and the input enclosure 112 are all next to one another.

The PDMU 100 includes the first high-power outlets 130, the second high-power outlets 132, the intermediate power outlets 168, and the low-power outlets 170 all supported on and mounted to a common framework 106, which enables the PDMU 100 to service various power output requirements simultaneously from a single unit Each of the power outlets 130, 132, 168, 170 is connected to a dedicated circuit breaker that provide individualized protection against overloads and electrical faults, and ensures that in the event of an issue with one circuit/outlet, the issue is isolated and does not disrupt the other power outlets.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the PDMU 100 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A power distribution management unit comprising:
a frame assembly comprising:
a base; and
a framework coupled to and extending from the base;
an input enclosure coupled to and supported above the base by the framework, the input enclosure being configured to receive an input power;
a three-phase enclosure coupled to and supported above the base by the framework, the three-phase enclosure receiving the input power and comprising:
a first high-power outlet,
a first high-power switch configured to selectively supply or disconnect power to the first high-power outlet,
a second high-power outlet, and
a second high-power switch configured to selectively supply or disconnect power to the second high-power outlet, wherein the first high-power outlet is rated at a first current value and the second high-power outlet is rated at a second current value, wherein the first current value higher than the second current value;
a transformer enclosure coupled to and supported above the base by the framework, the transformer enclosure including a stepdown transformer configured to convert the input power from three-phase power to single-phase power; and
a single-phase enclosure coupled to the framework, the single-phase enclosure receiving the single-phase power and comprising:
a plurality of intermediate-power outlets, and
a plurality of low-power outlets.

2. The power distribution management unit of claim 1 wherein the first high-power outlet and the second high-power outlet are rated at the same voltage.

3. The power distribution management unit of claim 2, wherein the first high-power outlet and the second high-power outlet are rated at about 480V.

4. The power distribution management unit of claim 1, further comprising:
a plurality of circuit breakers, wherein each the first high-power outlet, the second high-power outlet, the plurality of intermediate-power outlets, and the plurality of low-power outlets is electrically coupled to a respective one of the plurality of circuit breakers.

5. The power distribution management unit of claim 1, further comprising:
a plurality of ground-fault circuit interrupters (GFCIs), wherein each the first high-power outlet, the second high-power outlet, the plurality of intermediate-power outlets, and the plurality of low-power outlets is electrically coupled to a respective one of the plurality of GFCIs.

6. The power distribution management unit of claim 1, wherein the plurality of intermediate-power outlets is rated at a voltage of about 240V and the plurality of low-power outlets is rated at a voltage of about 120V.

7. The power distribution management unit of claim 1, wherein the first high-power outlet is rated at a current of about 60 A, the second high-power outlet is rated at a current of about 30 A, the plurality of intermediate-power outlets is rated at a current of about 30 A, and the plurality of low-power outlets is rated at a current of about 20 A.

8. The power distribution management unit of claim 1, the base further comprising:
a pair of fork pockets extending through channels formed in the base.

9. The power distribution management unit of claim 1, wherein the input enclosure is substantially parallel to the three-phase enclosure, and the single-phase enclosure is between the input enclosure and the three-phase enclosure.

10. The power distribution management unit of claim 1, wherein the three-phase enclosure further comprises:
a light indicator configured to emit light to indicate a status of the first high-power outlet, and a circuit breaker electrically coupled to the first high-power outlet;
wherein the light indicator is configured to cease emitting light when the circuit breaker faults.

11. The power distribution management unit of claim 1, the three-phase enclosure further comprising:
a light indicator configured to emit light, and
a circuit breaker electronically connected to the second high-power outlet;
wherein the light indicator is configured to cease emitting light when the circuit breaker faults.

12. The power distribution management unit of claim 1, the three-phase enclosure further comprising:
a light indicator configured to indicate a status of the first high-power outlet, the light indicator comprising:
a first light source configured to emit light, the first light source configured to cease emitting light when a first phase loss occurs,
a second light source configured to emit light, the second light source configured to cease emitting light when a second phase loss occurs; and
a third light source configured to emit light, the third light source configured to cease emitting light when a third phase loss occurs.

13. The power distribution management unit of claim 12, wherein the first light source, the second light source, and the third light source are arranged in a line substantially parallel to the base and above the second high-power switch.

14. The power distribution management unit of claim 1, the three-phase enclosure further comprising:
a light indicator configured to indicate a status of the second high-power outlet, the light indicator comprising:
a first light source configured to emit light, the first light source configured to cease emitting light when a first phase loss occurs,
a second light source configured to emit light, the second light source configured to cease emitting light when a second phase loss occurs; and
a third light source configured to emit light, the third light source configured to cease emitting light when a third phase loss occurs.

15. The power distribution management unit of claim 1, wherein the first high-power outlet and the second high-power outlet are arranged in a straight line substantially parallel to the base, and the first high-power outlet and the second high-power outlet are below the first high-power switch and the second high-power switch.

16. The power distribution management unit of claim 1 wherein the first high-power outlet is perpendicular to the plurality of low-power outlets and the second high-power outlet is perpendicular to the plurality of low-power outlets.

17. The power distribution management unit of claim 1, wherein the three-phase enclosure defines the input enclosure, and the input power is supplied directly to the three-phase enclosure.

18. The power distribution management unit of claim 1, further comprising:
a user interface configured to display the input power, a power to the first high-power outlet, a power to the second high-power outlet, a power to the plurality of intermediate-power outlets, a power to the plurality of low-power outlets, a power to the stepdown transformer, a power from the stepdown transformer, or a combination thereof.

19. A power distribution management unit comprising:
a frame assembly comprising:
a base; and
a framework coupled to and extending from the base;
an input enclosure coupled to and supported above the base by the framework, the input enclosure being configured to receive an input power;
a three-phase enclosure coupled to and supported above the base by the framework, the three-phase enclosure receiving the input power and comprising:
a first high-power outlet;
a second high-power outlet, wherein the first high-power outlet is rated at a first current value and the second high-power outlet is rated at a second current value, wherein the first current value higher than the second current value; and
a light indicator configured to indicate a status of the first high-power outlet or the second high-power outlet, the light indicator comprising:
a first light source configured to emit light, the first light source configured to cease emitting light when a first phase loss occurs;
a second light source configured to emit light, the second light source configured to cease emitting light when a second phase loss occurs; and
a third light source configured to emit light, the third light source configured to cease emitting light when a third phase loss occurs;
a transformer enclosure coupled to and supported above the base by the framework, the transformer enclosure including a stepdown transformer configured to convert the input power from three-phase power to single-phase power; and
a single-phase enclosure coupled to the framework, the single-phase enclosure receiving the single-phase power and comprising:
a plurality of intermediate-power outlets, and
a plurality of low-power outlets.

20. A power distribution management unit comprising:
a frame assembly comprising:
a base; and
a framework coupled to and extending from the base;
an input enclosure coupled to and supported above the base by the framework, the input enclosure being configured to receive an input power;
a three-phase enclosure coupled to and supported above the base by the framework, the three-phase enclosure receiving the input power and comprising:
a first high-power outlet,
a first high-power switch configured to selectively supply or disconnect power to the first high-power outlet,
a second high-power outlet, and
a second high-power switch configured to selectively supply or disconnect power to the second high-power outlet, wherein the first high-power outlet is rated at a first current value and the second high-power outlet is rated at a second current value, wherein the first current value higher than the second current value;
a transformer enclosure coupled to and supported above the base by the framework, the transformer enclosure including a stepdown transformer configured to convert the input power from three-phase power to single-phase power; and
a single-phase enclosure coupled to the framework, the single-phase enclosure receiving the single-phase power and comprising:
a plurality of intermediate-power outlets, and
a plurality of low-power outlets;
wherein the transformer enclosure is below the single-phase enclosure and between the input enclosure and the three-phase enclosure.
